(19) United States
(12) Patent Application Publication
(10) Pub. No.: US 2022/0061347 A1
(43) Pub. Date: Mar. 3, 2022

(54) LIPASE-TREATED FOOD PRODUCTS

(71) Applicant: Darifair Foods, LLC, Jacksonville, FL (US)

(72) Inventors: Luis Martinez, Jacksonville, FL (US); Stephen Koltun, Jacksonville, FL (US); Peter Bradley, Jacksonville, FL (US)

(21) Appl. No.: 17/387,182

(22) Filed: Jul. 28, 2021

Related U.S. Application Data
(60) Provisional application No. 63/070,011, filed on Aug. 25, 2020.

(51) Int. Cl. A23C 9/12; A23C 9/13; A23C 13/16; A23C 13/14; A23L 23/00

(52) U.S. Cl. CPC A23C 9/1213; A23C 9/1307; A23L 23/00; A23C 13/14; A23C 13/16

(57) ABSTRACT

Provided are a method for preparing a food product, which uses a lipase to catalyze the hydrolysis of fat and phospholipids in a base composition, and a food product produced by the method. The present method may increase the viscosity of the base composition having a low fat content and/or improve the stability of the food product even without added emulsifiers.

### CROSS-REFERENCE TO RELATED APPLICATIONS

This application claims the benefit of and priority to U.S. Provisional Application No. 63/070,011, filed on Aug. 25, 2020, the entire content of which is hereby incorporated by reference.

### BACKGROUND

Dairy products include suspensions of milk fat in an aqueous phase (including water and other milk components such as proteins, sugars, etc.), which may be converted into a blend from which other value-added products such as sauces, soups, dressings, etc., are produced. Milk products may be homogenized to reduce the particle size of the milk fat and therefore increase the surface area over the liquid fraction, resulting in a more stable, viscous blend. However, these blends, even when homogenized, tend to separate over the course of shelf life, resulting in fat rising to the top and heavier solids to the bottom of a container. In some cases, flocculation may occur whereby solids fall out of solution and precipitate to the bottom.

Dairy products have two major proteins: casein and whey. Either may be used for its nutritional value and/or its functionality. Casein is important for the body and flavor of dairy products. Various viscosities can be achieved by adjusting the culturing process and selecting the particular cultures to use in the fermentation process. Whey proteins are heat coagulating proteins. Whey protein denatures under heat conditions resulting in changes in the body and the viscosity of the dairy product. Whey proteins are usually used as viscosity increasing ingredients in soups, sauces, etc.

Dairy products are often formulated with other thickening agents such as gums and starches. Thickening agents, whether native or modified, contribute to mouthfeel and to the rheology of the finished product. Additionally, milk products are often formulated with emulsifying agents such as lecithin, mono and diglycerides, etc. to increase its stability and to prevent separation. Products which have been modified by the addition of texturizing ingredients and emulsifiers may not be labelled as “clean.”

Lower fat dairy products (e.g., 10% or less milk fat content), while having nutritional benefits compared to their higher fat counterparts, have inferior mouth feel, or lack the desired viscosity compared to products with regular or high fat content. Dairy products in general, regardless of fat content or processing method, lack enough stability which leads to separation or syneresis. The existing technology for modifying stability and viscosity often proves to be inadequate from a clean label perspective and/or unsuitable due to the addition of non-dairy ingredients or ingredients the market or industry will not permit.

In view of the foregoing, there remains a need for food products (e.g. dairy products) having satisfactory stability, mouthfeel, and viscosity, as well as methods for producing such products. It is desired that such methods would not require added thickening or emulsifying agents, resulting in clean label and more cost-effective products.

### SUMMARY

In an aspect, the present disclosure provides a method for preparing a food product, comprising mixing a lipase with a base composition comprising a phospholipid and 0% to about 99% by weight of fat, wherein the lipase hydrolyzes the phospholipid, the milk fat, or a combination thereof. In some embodiments, the base composition comprises a milk, a modified milk, a plant-based milk alternative, or a combination thereof.

In another aspect, provided is a food product produced by the method as disclosed herein.

### BRIEF DESCRIPTION OF THE DRAWINGS

FIG. 1 shows a representative process flow chart.

FIG. 2 shows the viscosity values of 10% fat milk blends that were untreated (control) or treated with lipase.

FIGS. 3A-3G show the viscosity values of dairy products of various fat contents (5%-35%), which were either not treated (Control) or treated with Enzyme 1 (Enzyme 1) or Enzyme 3 (Enzyme 3). Viscosity values (cP) were measured over time (Days) after inactivation of the enzymes at approximately 40° F.

FIG. 4 shows representative results of a separation study of dairy samples at various fat contents (5%-35%) stored for 21 days. The samples were either not treated (Control) or treated with Enzyme 1 (Enzyme 1) or Enzyme 3 (Enzyme 3). The difference between the moisture level of the top layer and the moisture level of the bottom layer was recorded (Moisture Difference (%)).

### DETAILED DESCRIPTION

The present disclosure provides a method to modify the stability and viscosity of food products with a specific enzymatic treatment. The herein described methods may eliminate the need for hydrocolloids and emulsifiers as additives in food products. For example, the viscosity of a dairy blend having a low fat content (e.g., a 10% fat blend, such as half & half) may be modified to achieve a viscosity similar to that of sour cream or even cream cheese. As a result, low fat blends may be modified by the present method to have similar mouthfeel and viscosity as heavy cream and other high fat blends. In certain embodiments, the herein described methods do not involve culturing or denaturing any proteins present naturally in milk, thereby allowing them to be intact for further processing. The present technology may be applicable to various mixtures of milk and cream, and other combinations of ingredients that include or contain fat, which are standardized to a wide range of fat level.

Before any embodiments of the invention are explained in detail, it is to be understood that the invention is not limited in its application to the details of construction and the arrangement of components set forth in the following description. The invention is capable of other embodiments and of being practiced or of being carried out in various ways.

### 1. Definitions

Unless otherwise defined, all technical and scientific terms used herein have the same meaning as commonly understood by one of ordinary skill in the art. In case of conflict, the present document, including definitions, will control. Suitable methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “comprising,” “include(s),” “including,” “having,” “has,” “contain(s),” “containing,” and variants thereof, as used herein, are open-ended transitional phrases, terms, or words that are meant to encompass the items listed thereafter and equivalents thereof as well as additional items. The singular forms “a”, “and”, and “the” include plural references unless the context clearly dictates otherwise. Where the term “comprising” is used, the present disclosure also contemplates other embodiments “comprising,” “consisting of,” and “consisting essentially of,” the embodiments or elements presented herein, whether explicitly set forth or not. Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

Definitions of specific functional groups and chemical terms are described in more detail below. For purposes of this disclosure, the chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5th Edition, John Wiley & Sons, Inc., New York, 2001; Larock, Comprehensive Organic Transformations, VCH Publishers, Inc., New York, 1989; Carruthers, Some Modern Methods of Organic Synthesis, 3rd Edition, Cambridge University Press, Cambridge, 1987; the entire contents of each of which are incorporated herein by reference.

The term “essentially free of” means that a composition contains a component in an amount of less than 1% by weight of the composition. This includes less than 0.5% by weight, less than 0.1% by weight, less than 0.05% by weight, or even less than 0.01% by weight. Compositions “essentially free of” a component also include a composition that is completely free of that component.

The term “lipase” as used herein refers to an enzyme which catalyzes the hydrolysis of ester bonds in lipid substrates such as fats, oils, and phospholipids. The lipase may include natural and recombinant enzymes known in the art. The lipase may be obtained from animal tissues (such as stomach or pancreas of cows, pigs, and goats), plants (such as various plant seeds), or microorganisms (such as bacteria, fungi, and yeast).

The term “lysophospholipid” as used herein means a derivative of a phospholipid after one or more of the fatty acid groups are removed.

The term “milk” as used herein refers to any animal milk (such as cow milk) suitable for human consumption. The term “modified milk” as used herein refers to any formulation derived from milk, in which the content of at least one of the components of the milk, such as fat, protein, carbohydrates, ash, or water, is modified, or at least one ingredient not present in the original milk is added, or both. For example, the modified milk may result from a milk after being treated by a known fat standardization process. The milk or modified milk as used herein include any dry form (e.g., powder) of such milk or modified milk.

The term “plant-based milk alternative” refers to a product derived from a plant, for example by soaking, boiling, grinding, and/or blending the whole plant or a part of the plant (e.g., a fruit and/or a seed), which is suitable for human consumption. As a result, the plant-based milk alternative includes one or more nutrients, such proteins, fats, carbohydrates, fibers, vitamins, and minerals, etc., extracted from the plant. The plant-based milk alternative may have a texture or mouth feel similar to that of a milk. Examples of plant-based milk alternatives include oat milk, soy milk, coconut milk, almond milk, cashew milk, rice milk, hemp milk, pea milk, hazelnut milk, and tiger nut milk, etc., produced by manufacture processes known in the art. The plant-based milk alternatives as used herein include any dry form (e.g., powder) of such product.

The term “phospholipid” as used herein includes organic molecules having two fatty acid groups and a phosphate head group attached to a glycerol backbone. The phosphate head group may include an organic moiety such as choline, ethanolamine, inositol, or serine. The phospholipids described herein include any naturally occurring phospholipids in cellular membrane, such as phosphatidylcholine (PC), phosphatidylethanolamine (PE), phosphatidylinositol (PI), phosphatidylserine (PS), and sphingomyelin (SM).

### 2. Method

In one aspect, the present disclosure provides a method for preparing a food product. The method may comprise mixing a lipase with a base composition. The base composition may comprise a phospholipid and from 0% to about 99% by weight of fat, wherein the lipase catalyzes a hydrolysis of the phospholipid, the fat, or a combination thereof.

The base composition may comprise a milk, a modified milk, a plant-based milk alternative, or a combination thereof. In some embodiments, the base composition comprises a milk. In some embodiments, the base composition comprises a modified milk. In some embodiments, the base composition comprises a plant-based milk alternative.

The base composition may comprise phospholipids found in raw milk and other dairy products. In some embodiments, the base composition comprises a milk, a modified milk, a plant-based milk alternative, or a combination thereof, and the phospholipid of the base composition comprises the phospholipid present in the milk, the modified milk, a plant-based milk alternative, or the combination thereof. In some embodiments, the base composition comprises a milk, a modified milk, a plant-based milk alternative, or a combination thereof, and the phospholipid of the base composition consists the phospholipid present in the milk, the modified milk, the plant-based milk alternative, or the combination thereof.

The base composition may comprise about 0.01% to about 5% by weight of phospholipid. In some embodiments, the base composition may include, by weight of the total phospholipid, about 8.0% to about 45.5% phosphatidylcholine, about 26.4% to about 72.3% phosphatidylethanolamine, about 1.4% to about 14.1% phosphatidylinositol, about 2.0% to about 16.1% phosphatidylserine, and about 4.1% to about 29.2% sphingomyelin.

The base composition may include natural milk fat (or butter fat) or fat of other sources, which includes triglycerides with various fatty acid components. In some embodiments, the base composition comprises a milk, a modified milk, a plant-based milk alternative, or a combination thereof, and the fat of the base composition comprises the fat present in the milk, the modified milk, a plant-based milk alternative, or the combination thereof. In some embodiments, the base composition comprises a milk, a modified milk, a plant-based milk alternative, or a combination thereof, and the fat of the base composition consists the fat present in the milk, the modified milk, the plant-based milk alternative, or the combination thereof.

The base composition may comprise about 0.1% to about 99% by weight of fat, including about 0.1% to about 80%, about 0.1% to about 60%, about 0.1% to about 45%, about 1% to about 45%, about 1% to about 40%, about 5% to about 40%, about 5% to about 30%, about 5% to about 25%, or about 5% to about 15% by weight of fat. The base composition may comprise about 5%, about 10%, about 15%, about 20%, about 25%, about 30%, about 35%, or about 40% by weight of fat. In certain embodiments, the base composition comprises about 10% by weight of fat.

In certain embodiments, the base composition comprises a modified milk, the phospholipid of the base composition consists of the phospholipid present in the modified milk, and the fat of the base composition consists of the fat present in the modified milk. In such embodiments, the fat content of the base composition may be about 0.1% to about 60% by weight, such as about 0.1% to about 45%, about 1% to about 45%, about 1% to about 40%, about 5% to about 40%, about 5% to about 30%, about 5% to about 25%, or about 5% to about 15% by weight. The modified milk may be derived from a raw milk using known techniques. For example, the modified milk may be produced from a raw milk following a fat standardization process, in which the fat content is adjusted to a pre-determined level.

The lipase as disclosed herein includes, but are not limited to, triacylglycerol lipases capable of hydrolyzing triglycerides and phospholipases capable of hydrolyzing phospholipids. The triacylglycerol lipase may include, for example, enzymes under Enzyme Commission number EC 3.1.1.3 or E.C. 232-619-9, enzymes under Chemical Abstracts Service Registry Number (CAS No.) 9001-62-1, and enzymes under International Union of Biochemistry number (IUB No.) 3.1.1.3. The phospholipase may be, for example, phospholipase A1, phospholipase A2, phospholipase B, phospholipase C, and/or phospholipase D. The lipase may contain both triacylglycerol lipase and phospholipase properties. The lipase may catalyze the hydrolysis of one or two fatty acyl chains from the fat or the phospholipid, the hydrolysis of the phosphate head group from the phospholipid, or a combination thereof. In some embodiments, the lipase is a phospholipase that catalyzes the hydrolysis of one fatty acyl chain from the phospholipid to produce a lysophospholipid.

In some embodiments, one lipase (a triacylglycerol lipases or a phospholipase) is used to catalyze the hydrolysis of the fat and/or the phospholipid. In some embodiments, two or more lipases are used to catalyze the hydrolysis of the fat and/or the phospholipid. In some embodiments, at least a portion of the phospholipids in the base composition is hydrolyzed. In some embodiments, at least a portion of the fat in the base composition is hydrolyzed. In some embodiments, at least a portion of the phospholipids and at least a portion of the fat in the base composition are hydrolyzed.

Suitable lipases include those obtained from animal, plant, bacteria, fungus, or genetically engineered microorganisms. In some embodiments, the lipase includes one or more phospholipases and/or one or more triacylglycerol lipases, each of which is obtained from an animal, a plant, or microbial fermentation.

The base composition may be pasteurized and homogenized using known techniques before mixing with the lipase. The mixing may be carried out using known techniques. Other procedures may be utilized to facilitate the mixing of the base composition and the lipase, as well as the hydrolysis of fat and/or phospholipids catalyzed by the lipase. Such procedures may include, for example, heating, cooling, stirring, shaking, incubating, pH adjustment, and other known techniques.

The lipase-catalyzed hydrolysis may be carried out at a temperature of about 30° F. to about 160° F., such as about 50° F. to about 150° F., or about 75° F. to about 125° F. The hydrolysis may be carried out at about 35° F., about 40° F., about 45° F., about 50° F., about 55° F., about 60° F., about 65° F., about 70° F., about 75° F., about 80° F., about 85° F., about 90° F., about 95° F., about 100° F., about 105° F., about 110° F., about 115° F., about 120° F., about 125° F., about 130° F., about 135° F., about 140° F., or about 145° F.

The lipase-catalyzed hydrolysis may be carried out for a time period of about 10 minutes to about 150 minutes. The hydrolysis may be carried out for a time period of about 30 minutes, about 40 minutes, about 50 minutes, about 60 minutes, about 70 minutes, about 80 minutes, about 90 minutes, about 100 minutes, about 110 minutes, about 120 minutes, about 130 minutes, or about 140 minutes. In some embodiments, the hydrolysis was carried out at a temperature of about 75° F. to about 125° F. for a period of about 30 minutes.

The present method may further include adding a flavorant, such as the natural or artificial flavor compounds known in the art. The flavorant may improve the sensory quality (e.g., pleasant taste and smell) of the final product. Suitable flavorants include natural and artificial flavors, such as salt (NaCl), sugar, herb extracts, fruit extracts, vegetable extracts, spices, or a combination thereof. The flavorant may be added before or after the lipase-catalyzed hydrolysis of the base composition. In some embodiments, the flavorant is added after the lipase-catalyzed hydrolysis.

The present method may further include adding one or more antioxidants to control the oxidation level during production or storage of the product. Suitable antioxidants include compounds such as phenols, carotenoids, curcumins, xanthones, vitamins A, E and C, citric acid, flavonoids, terpenoids, lignans, sulfides, plant sterols, and combinations thereof. The one or more antioxidants may be added before or after the lipase-catalyzed hydrolysis of the base composition. In some embodiments, the antioxidant is added to the base composition before the lipase-catalyzed hydrolysis.

The present method may further include a step of inactivating the lipase following the hydrolysis. The inactivation may be performed using known techniques, such as heat treatment. In some embodiments, the lipase is inactivated by heating at a temperature of at least 160° F., including, for example, at least 165° F., at least 170° F., at least 180° F., or at least 200° F. In some embodiments, the lipase is inactivated by heating at temperature of about 165° F.

Viscosity is a measurement of a fluid's resistance to flow. Viscosity values may be used describe the mouth feel of a food product. In dairy products, viscosity at a given temperature is dependent upon its composition and the physical state of its colloidally dispersed substances, including fat. Homogenization may increase a dairy product's viscosity due to the increased surface area and dispersed state of the fat. Advantageously, the present method may significantly increase the viscosity of a base composition having a lower fat content (e.g., 10% fat) to a level similar to that of products having much higher fat content, such as sour cream (about 20% fat) or even cream cheese (about 35% fat). As a result, low fat base compositions (such as low fat milk) may be modified by the present method to have similar mouthfeel and viscosity comparable to those of heavy cream and high fat products.

In addition, the present method may improve the stability of the food product, with or without using hydrocolloids and emulsifiers as additives. For example, phase separation occurs in dairy products over the course of shelf life because cream, or butterfat, is lighter than other components in milk. Homogenization may reduce phase separation by reducing the size of fat globules, thus increasing their surface area and resulting in a more uniform and stable distribution of fat throughout the aqueous phase. Emulsifiers may be utilized to reduce the degree of separation by decreasing the surface tension between the water and oil phases. Emulsifiers function by having both hydrophilic and hydrophobic properties to interact with both phases (also known as amphipathic character).

Without being limited by any theory, the lysophospholipids produced from phospholipids (e.g., catalyzed by the phospholipase) may function as endogenous emulsifiers that lead to increased stability of the food product, such as a dairy product. In addition, the production of monoglycerides, diglycerides, and free fatty acids from triglycerides (e.g., catalyzed by the triacylglycerol lipase) may increase the surface area of the fat, which leads to increased body and further improves the stability of the dairy product. Most of the phospholipids in milk are located in the milk fat globule membrane (MFGM) or the outer layer of milk fat that encapsulates micelles. The lipase may cause disintegration of these membranes by hydrolyzing the membrane phospholipids, thereby releasing the encapsulated amphipathic fat molecules. Thus, the method described herein may reduce phase separation and improve the stability of the food product, without the use of added emulsifiers.

The present method may be performed under mild conditions so as to keep the proteins in the food product (such as milk proteins) intact, allowing the food product to maintain its protein composition, which may be further processed or incorporated into other products.

### 3. Composition

In another aspect, the present disclosure provides a food product produced by the method as described herein. In some embodiments, the food product is a dairy product (such as a dairy blend) produced from milk.

The food product may have a fat content of about 1% to about 90% by weight. The food product may have a fat content of at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, or at least 85% by weight. The food product may have a fat content of at most 85%, at most 80%, at most 75%, at most 70%, at most 65%, at most 60%, at most 55%, at most 50%, at most 45%, at most 40%, at most 35%, at most 30%, at most 25%, at most 20%, at most 15%, at most 10%, or at most 5% by weight. The food product may have a fat content of about 1% to about 80%, about 1% to about 60%, about 1% to about 45%, about 2% to about 45%, about 5% to about 45%, about 5% to about 40%, about 5% to about 35%, about 5% to about 30%, about 5% to about 25%, about 5% to about 20%, or about 5% to about 15% by weight. In some embodiments, the food product has a fat content of about 5% to about 25% by weight. In some embodiments, the food product has a fat content of about 2%, about 5%, about 10%, about 15%, about 20%, about 25%, or about 30% by weight.

The food product may have a viscosity of about 1000 cP to about 1500000 cP at 40° F. The food product may have a viscosity of at least 1000 cP, at least 5000 cP, at least 10000 cP, at least 50000 cP, at least 100000 cP, at least 200000 cP, at least 300000 cP, at least 400000 cP, at least 500000 cP, at least 600000 cP, at least 700000 cP, at least 800000 cP, at least 1000000 cP, or at least 1200000 cP at 40° F. The food product may have a viscosity of about 10000 cP to about 1200000 cP, about 20000 cP to about 1200000 cP, about 20000 cP to about 1000000 cP, about 20000 cP to about 800000 cP, about 20000 cP to about 600000 cP, about 20000 cP to about 400000 cP, about 20000 cP to about 200000 cP, or about 20000 cP to about 100000 cP at 40° F. The food product may have a viscosity of about 100000 cP to about 1000000 cP, about 100000 cP to about 800000 cP, about 100000 cP to about 600000 cP, about 100000 cP to about 500000 cP, about 100000 cP to about 400000 cP, about 100000 cP to about 300000 cP, or about 100000 cP to about 200000 cP at 40° F.

The food product may be stable (e.g., with minimal or no phase separation) for at least 10 days in a closed container at temperature between 0° C. to about 25° C. The food product may be stored under refrigerated conditions (e.g., about 4° C. or 40° F.). The stability of the food product may include physical stability (e.g., as demonstrated by minimal or no phase separation) and chemical stability (e.g., as demonstrated by low microbial growth) during storage. In some embodiments, the food product may be stable for at least 15 days, at least 20 days, at least 30 days, at least 40 days, at least 50 days, or even at least 60 days at 40° F.

The food product produced by the method as described herein may be essentially free of emulsifiers or texturizing agents that are added to known products. For example, the food product may be essentially free of added emulsifiers, such as soy and egg lecithin, mono- and diglycerides, polysorbates, carrageenan, guar gum, or canola oil. The food product may be essentially free of added texturing ingredients, such as starches, soy proteins, alginates, pectin, xanthan gum, carrageenan, and galactomannans. In some embodiments, the food product does not include any added emulsifiers or texturizing ingredients.

The present food product, as a result of the lipase treatment described herein, may enhance salt perception compared to a product that is not treated by lipase. The enhancement of salt perception may be measured by a panel that is trained using standards with known concentrations of salt. The panel reports a perceived salt concentration for a sample, which indicates the observed salt perception in that sample. In some embodiments, the panel indicates at least 1.5-fold, at least 5-fold, or even at least 10-fold increase in salt perception for the lipase treated samples, compared to the control sample containing the same amount of salt.

The food product may further comprise other food additives known in the art, such as antioxidants, flavorants, vitamins, colorants, sweeteners, preservatives, or a combination thereof.

The food product produced by the method as described herein may be a dairy blend. The food product may be in the form of a liquid, a cream, a semi-solid, or a solid. The food product may be included to formulate a ready-to-use food composition for cooking or consumption, such as a sauce, a salad dressing, a drink, or a soup. The herein described food product (e.g., 10% fat), as a result of lipase treatment described herein, may achieve sensory performance (such as flavor, creaminess, and overall liking) that is comparable to a control product having a much higher fat level (e.g., 40% fat).

### EXAMPLES

### Example 1. Lipase Treatment of a Milk Composition

All industrial and lab instruments for dairy product processing as used herein are commercially available, including separator, blend tank, scale, pasteurizer, homogenizer, cooling press, heating tank, steam jacketed kettle, tote, and metalized dairy bags.

The lipase enzymes tested are shown below.

| | Enzyme 1 | Enzyme 3 | Enzyme 4 | Enzyme 5 | Enzyme 6 |
|---|---|---|---|---|---|
| Protein | E.C. 3.1.1.3 | CAS No. 9001- | CAS No. 9001- | CAS No. 9001- | CAS No. 9001- |
| ID | | 62-1 | 62-1 | 62-1 | 62-1 |
| | | IUB No. 3.1.1.3 | | | E.C. 232-619-9 |
| Activity | Phospholipase | Triacylglycerol | Triacylglycerol | Triacylglycerol | Triacylglycerol |
| | type A1 | lipase | lipase | lipase | lipase |
| Origin | Microbial | Microbial | Animal | Microbial | Animal |
| | Fermentation | Fermentation | | Fermentation | |

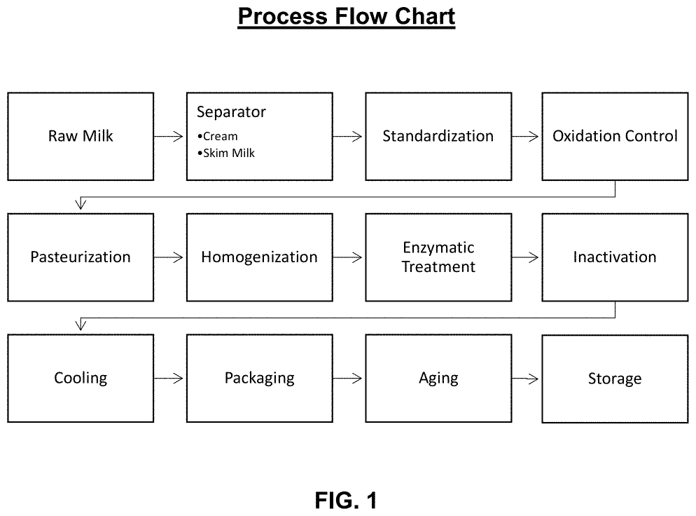

A representative procedure is shown in FIG. 1. Cream and skim milk were separated using a separator. Subsequently, a blend having a 10% milk fat was obtained following a fat standardization step. Antioxidant (0.2% was added), and the resulting composition was pasteurized at 165° F. (with a 40-second hold). The pasteurized composition was subjected to a homogenization process (1500 PSI first stage, 500 PSI second stage), and the homogenized composition was incubated with the lipase for 30 minutes at 75-125° F. (Enzyme 1: 0.2-0.54% by weight; Enzyme 3: 0.2-0.45% by weight). The enzyme was inactivated by heating at 165° F. (with a 6-minute hold), and the resulting composition was then cooled to below 40° F., packed, and was allowed to age and stored in a manner to control exposure to light.

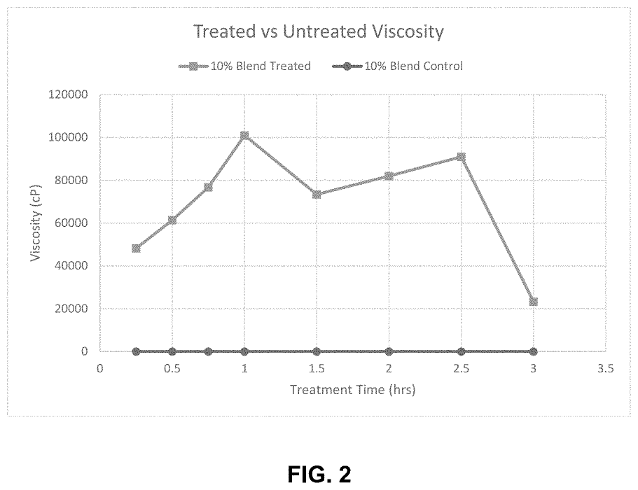

The viscosity values of the untreated (control) and the enzyme treated 10% fat milk blends were measured over time (FIG. 2). The results showed that the change in viscosity was solely related to the enzymatic treatment and that other factors (such as protein denaturation) was not the cause of such change. Both untreated and treated blends were subjected to the same time and temperature variables.

### Example 2. Viscosity Study

The viscosity values of the products from the lipase treatment process were studied. A rheometer was used to measure the way in which a liquid, suspension or slurry flows in response to applied forces. It is used for those fluids which cannot be defined by a single value of viscosity and therefore requires more parameters to be set and measured than is the case for a viscometer. In the absence of a rheometer, a viscometer was used to measure fluid viscosity in centipoise (cP) at given shear rates.

The process started with raw milk that is separated into cream and skim fractions. The resulting intermediate was standardized to a certain fat content (5%-35%) and controlled for light. The fluid dairy was sent through a high-temperature short-time (HTST) process where it is pasteurized in adherence to Pasteurized Milk Ordinance (PMO) standards and homogenized. The fluid dairy was either not treated (Control), treated with Enzyme 1 (Enzyme 1), or treated with Enzyme 3 (Enzyme 3) at a specific time and temperature as described above. The product was then subjected to a second heat treatment process for inline inactivation, after which the product was cooled. The cooled product was then packaged, aged, and stored.

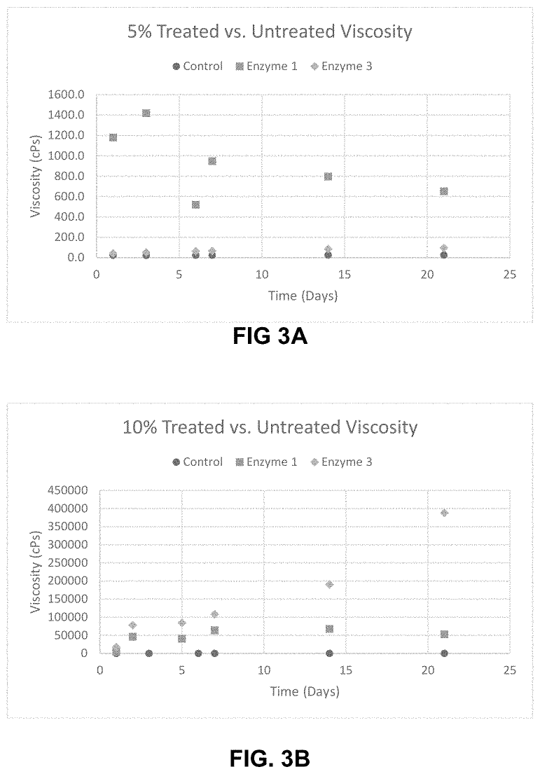

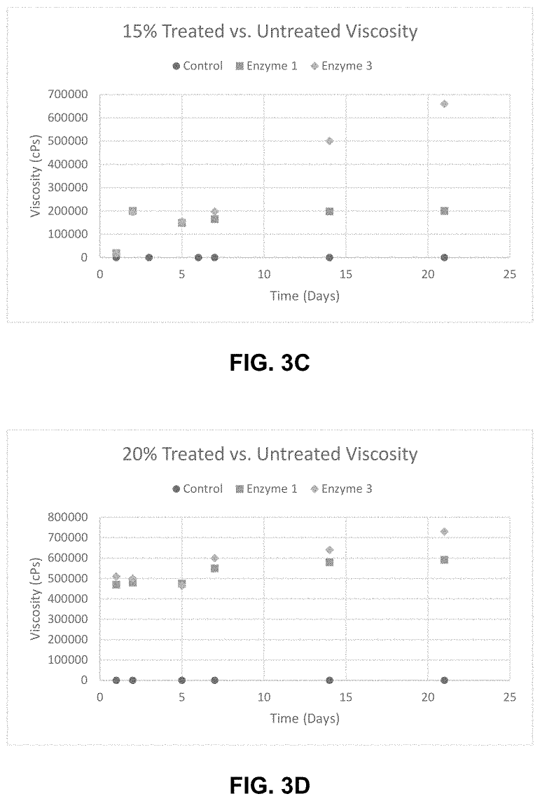

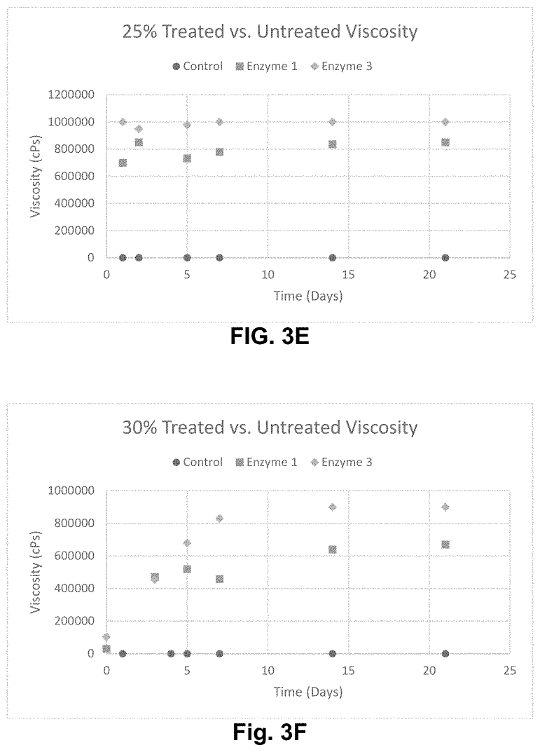

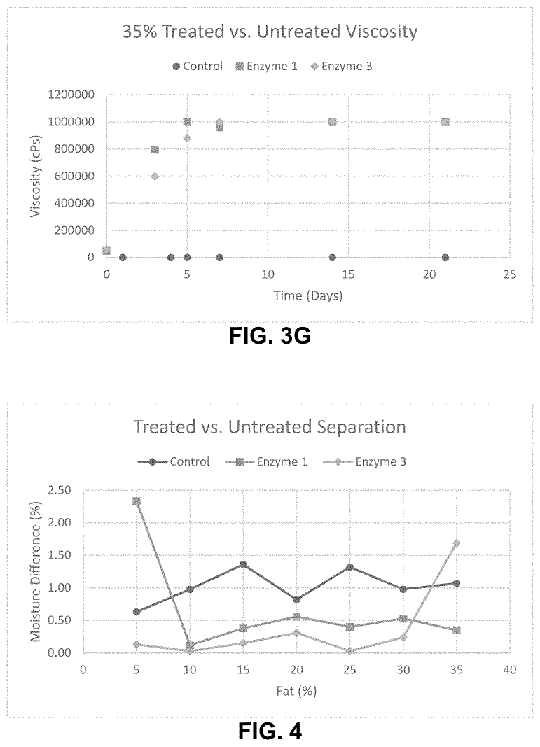

The viscosities for the products from each fat content under each treatment (Control, Enzyme 1, Enzyme 3) were measured over time (a total of 21 trials). Typically, after enzyme inactivation, the products were separately agitated and poured into 15 oz jars and labeled accordingly. Samples were stored in a cooler at 40° F. At different time points (1, 3, 5, 7, 14, and 21 days), viscosity for each product was measured using a Brookfield viscometer. Different RV Spindles and T-Bar Spindles were used depending on the viscosity of the product. As shown in FIGS. 3A-3G, the lipase treatment significantly increases the viscosity of dairy products (higher cP values), allowing them to emulate the viscosity and mouth feel of higher fat products.

### Example 3. Separation Study

Further tests were conducted to measure the degree of separation in the lipase treated products as described above. Typically, products from each fat content (5%-35%) under each treatment (Control, Enzyme 1, Enzyme 3) were separately agitated and poured into 100 mL graduated cylinders and labeled accordingly. Samples were stored in a cooler at 40° F. After 21 days, a picture was taken for each sample to visually measure the separation of the sample into a top layer and a bottom layer. A glass pipette fitted with a rubber bulb was used to take an aliquot from each of the top and bottom layers. Moisture contents (percentage) in the aliquots were measured using a moisture analyzer. The difference between the moisture level of the top layer and the moisture level of the bottom layer was recorded (Moisture Difference (%)), as shown in FIG. 4. Since fat is lighter than other components in milk, a greater moisture difference between the top layer and the bottom layer indicates greater separation.

### Example 4. Lysophospholipid Production

The lipase treatment produced lysophospholipids from the naturally occurring fat matrix available in dairy products. It is hypothesized that the lysophospholipids produced from phospholipids function as endogenous emulsifiers and lead to increased stability of the dairy product. In a representative study, raw milk was separated into cream and skim fractions, and was then standardized to 10% fat content and controlled for light. The fluid dairy was sent through a high-temperature short-time (HTST) process where it is pasteurized in adherence to Pasteurized Milk Ordinance (PMO) standards and homogenized. The fluid dairy was then either not treated (Control) or treated with Enzyme 1 at a specific time and temperature as described above. The product was then subjected to a second heat treatment process for inline inactivation, after which the product was cooled. The cooled product was then packaged, aged, and stored.

Production of lysophospholipids was measured by quantitative 31P-NMR spectroscopy using a Bruker Avance III HD 600 MHz NMR spectrometer with automated sample changer and BBO cryoprobe and an internal standard of triphenyl phosphate (TPP). As shown in Table 1, the lipase treatment resulted in significant reduction of phosphatidylcholine and phosphatidylethanolamine contents and production of 2-lysophosphatidylcholine as a major lysophospholipid. The nondetectable amount of lysophosphatidylethanolamine may indicate a complete consumption of phosphatidylethanolamine by the lipase. The relatively constant amount of sphingomyelin in both Control and Enzyme 1 samples may indicate that the sphingomyelin was not significantly metabolized by the enzyme.

TABLE 1

| | Molecular | Control | Enzyme 1 |
|---|---|---|---|
| Phospholipid | Weight | (mol. %) | (mol. %) |
| Phosphatidylcholine | 757.0 | 33.9 | 6.1 |
| 2-Lysophosphatidylcholine | 515.0 | n.d. | 10.3 |
| Phosphatidylethanolamine | 755.0 | 6.8 | n.d. |
| Lysophosphatidylethanolamine | 470.0 | n.d. | n.d. |
| Sphingomyelin | 770.0 | 27.6 | 41.9 |

### Example 5. Shelf Life Study

According to the Pasteurized Milk Ordinance (PMO), the terms “pasteurization”, “pasteurized” and similar terms shall mean the process of heating every particle of milk or milk product, in properly designed and operated equipment, to one (1) of the temperatures given in the following chart and held continuously at or above that temperature for at least the corresponding specified time.

Batch (Vat) Pasteurization

| Temperature | Time |
|---|---|
| 63° C. (145° F.) | 30 minutes |

Continuous Flow (HTST and HHST) Pasteurization

| Temperature | Time |
|---|---|
| 72° C. (161° F.) | 15 seconds |
| 89° C. (191° F.) | 1.0 seconds |
| 90° C. (194° F.) | 0.5 seconds |
| 94° C. (201° F.) | 0.1 seconds |
| 96° C. (204° F.) | 0.05 seconds |
| 100° C. (212° F.) | 0.01 seconds |

If the fat content of the milk product is 10% or greater, or a total solids of 18% or greater, or if it contains added sweeteners, the specified temperature shall be increased by 3° C. (5° F.). Under the most favorable processing and storage conditions, this HTST pasteurization process is typically capable of extending the shelf life of fresh milk products for up to 3 weeks (21 days) depending on the initial microbiological quality of the raw milk, as demonstrated by fresh milk products on the shelf. Other methods are available for extending the shelf life of milk, but they typically involve changing the heating regime. The other traditionally applied process is ultra high temperature (UHT), which used a high temperature (>135° C.) for 1-2 seconds. UHT products can be stored at ambient temperatures and while boasting a longer shelf life, the increased temperature in the UHT process leads to organoleptic changes in the product like a “cooked” flavor note.

The shelf stability of the dairy produced by the present method was examined. The process started with raw milk that is separated into cream and skim fractions. It is standardized to a 10% fat content and controlled for light. The fluid dairy is sent through a high-temperature short-time (HTST) process where it is pasteurized in adherence to Pasteurized Milk Ordinance (PMO) standards and homogenized. The fluid dairy was either not treated (Control) or treated with a lipase (Enzyme 5 or Enzyme 6) (Treated) at a specific time and temperature as described above. The product was then subjected to a second heat treatment process for inline inactivation and cooling. The cooled product was packaged, aged, and stored.

In order to accurately measure an extension in shelf life, each sample was individually packed in twenty-four (24) separate sterile sample containers. Samples were stored in a cooler at 40° F. At different time points (0, 7, 14, 16, 19, 21, 23, 26, 27, 29, 30, 33, 35, 37, 40, 42, 44, 47, 49, 51, 54, 56, 58, and 61 days), the containers were taken out of the cooler and were sent to a lab for microbiological testing according to Association of Official Analytical Chemists (AOAC) methods and include aerobic plate count (APC) according to AOAC 990.12, total coliforms (C) according to AOAC 991.14, and yeast (Y) and mold (M) according to AOAC 2014.05 (Table 2). For reference, the PMO declares the bacterial limit is 20,000 colony forming units (CFU)/g for pasteurized milk and/or milk products to be considered Grade “A”.

As shown by the APC measurement, the Control sample confirmed a typical shelf life of 21 days for dairy products (APC<1,000,000). After 21 days, there was a steady microbiological growth in the Control sample (APC count increase to >40,000,000). By day 40, the Control sample was coagulated due to significant microbiological growth. In contrast, the enzyme treated product of the present method remained stable and maintained low APC count (<20,000) for at least 60 days. These results demonstrate that enzyme treatment process may effectively control the microbiological counts in the matrix, thus extending the shelf life of fresh dairy products. Preventing microbial growth and extending the shelf life can alleviate costs related to spoilage.

TABLE 2

| Day | Enzyme 5 | | | | Enzyme 6 | | | | | Control | | | | |
|---|---|---|---|---|---|---|---|---|---|---|---|---|---|---|
| (age) | C | APC | Y | M | C | APC | | Y | M | C | APC | | Y | M |
| 0 | <1 | 3 | <10 | <10 | <1 | 350 | | <10 | <10 | <1 | 0 | | | |
| 7 | <10 | 10 | <10 | <10 | <10 | 5,800 | | <10 | <10 | <10 | <10 | | <10 | <10 |
| 14 | <10 | <10 | <10 | <10 | <10 | 1,700 | | <10 | <10 | <10 | 710 | | <10 | <10 |
| 16 | <10 | <10 | <10 | <10 | <10 | 1,600 | | <10 | <10 | <10 | 160,000,000 | * | <10 | <10 |
| 19 | <10 | <10 | <10 | <10 | <10 | 1,400 | | <10 | <10 | <10 | 44,000 | | <10 | <10 |
| 21 | <10 | <10 | <10 | <10 | <10 | 1,100 | | <10 | <10 | 18,000 | 640,000,000 | * | <10 | <10 |
| 23 | <10 | <10 | <10 | <10 | <10 | 890 | | <10 | <10 | <10 | 1,100,000 | | <10 | <10 |
| 26 | <10 | 10 | <10 | <10 | <10 | 620 | | <10 | <10 | <10 | >2,500,000,000 | * | <10 | <10 |
| 27 | <10 | 10 | <10 | <10 | <10 | 120,000,000 | * | <10 | <10 | <10 | 13,000,000 | | <10 | <10 |
| 29 | <10 | 150 | <10 | <10 | <10 | 470 | | <10 | <10 | <10 | 43,000,000 | | <10 | <10 |
| 30 | <10 | <10 | <10 | <10 | <10 | 620 | | <10 | <10 | <10 | 31,000,000 | | <10 | <10 |
| 33 | <10 | <10 | <10 | <10 | <10 | 390 | | <10 | <10 | <10 | 37,000,000 | | <10 | <10 |
| 35 | <10 | <10 | <10 | <10 | <10 | 300 | | <10 | <10 | <10 | 75,000,000 | | <10 | <10 |
| 37 | <10 | 20 | <10 | <10 | <10 | 16,000 | | <10 | <10 | <10 | 43,000,000 | | <10 | <10 |
| 40 | <10 | <10 | <10 | <10 | <10 | 220 | | <10 | <10 | <10 | 8,100,000 | | <10 | <10 |
| 42 | <10 | 10 | <10 | <10 | <10 | 300 | | <10 | <10 | | | | | |
| 44 | <10 | <10 | <10 | <10 | <10 | 5,000 | | <10 | <10 | | | | | |
| 47 | <10 | 10 | <10 | <10 | <10 | 4,700 | | <10 | <10 | | | | | |
| 49 | <10 | 20 | <10 | <10 | <10 | 14,000 | | <10 | <10 | | | | | |
| 51 | <10 | <10 | <10 | <10 | <10 | 3,300 | | <10 | <10 | | | | | |
| 54 | <10 | 10 | <10 | <10 | <10 | 7,900 | | <10 | <10 | | | | | |
| 56 | <10 | 2,700 | <10 | <10 | <10 | <10 | | <10 | <10 | | | | | |
| 58 | <10 | 10 | <10 | <10 | <10 | 12,000 | | <10 | <10 | | | | | |
| 61 | <10 | <10 | <10 | <10 | <10 | 33,000 | | <10 | <10 | | | | | |

* numbers which may reflect accidental contamination during preparation and/or sampling.
Example 6. Enhancement of Salt Perception Study

Each of the four basic tastes (sweet, salt, sour, and bitter) can be influenced by the entire food matrix, not just a single ingredient. For example, sweetness perception is not only increased by increasing sugar content but also by pairing it with sour thus increasing the overall intensity of both. Here, the capacity of the present dairy product to enhance salt perception was examined.

In this study, the process started with raw milk that is separated into cream and skim fractions. The intermediate product was then standardized to a 10% fat content and controlled for light. The fluid dairy was sent through a high-temperature short-time (HTST) process where it is pasteurized in adherence to Pasteurized Milk Ordinance (PMO) standards and homogenized. The fluid dairy was either not treated (Control) or treated with one version of a lipase (Enzyme 6) at a specific time and temperature as described above. The product was then subjected to a second heat treatment process for inline inactivation and cooling. The cooled product was then packaged, aged, and stored.

In order to accurately measure salt perception, a trained panel was setup. Panelists were chosen based on their ability to pass a triangle test, which rates their ability to distinguish between three samples. A triangle test is a discriminative method where a panelist is presented with one different and two alike samples. Samples were presented in all possible permutations to reduce any presentation order biases and panelists were instructed to taste the samples from left to right to keep consistencies. The triangle test samples consisted of two dairy blends, one with 1.15% salt added and another with 1.39% salt added. These numbers were chosen because the difference threshold for humans is typically 15%, which is the extent of change in the stimulus necessary to produce a reliably noticeable difference. That percentage was increased to allow for more panelists in the trained panel. Seven (7) panelists passed the triangle test and were admitted in the trained panel.

Training was divided into nine (9) separate training sessions, with each session lasting roughly 30 minutes. Panelists were trained using five (5) separate reference standards, which consisted of dairy blends with a set amount of salt. The dairy blend reference standards contained 0.25%, 0.75%, 1.00%, 1.25%, and 1.75% salt respectively. The goal of the trained panel is to have participants familiarize themselves with the reference standards and make sure that panelists can accurately rate a product on the scale. The first training session was introducing the standards. The second training session determined if the panelists could place the reference standards in order of increasing intensity. The following four (4) training sessions, panelists were given three (3) samples each and were asked to place them on the scale with reference standards available. The final three (3) training sessions, panelists were given three (3) samples each and were asked to place them on the scale without reference standards available. At this point, the training was complete and panelists were considered trained once they were able to accurately place samples on the scale provided.

The analysis was conducted by presenting the control sample (Control) and enzyme treated samples (Treated) together with a set amount of salt added in two separate tests, with at least 10 minutes in between to allow for palette cleansing. Panelists were instructed to rate the two samples on a scale without reference standards available. There was a significant difference in salt intensity perception for the Control and Treated samples at alpha=0.05 for 0% salt and 0.50% salt addition (Table 3). These results indicate that the dairy product produced by the present method may enhance salt perception, thereby reducing the sodium content in the final product necessary to achieve the same overall flavor.

TABLE 3

| | Control | Treated | Control | Treated |
|---|---|---|---|---|
| Salt % | 0 | 0 | 0.5 | 0.5 |
| Mean | 0.036 | 0.21 | 0.357 | 0.657 |
| Variance | 0.004 | 0.002 | 0.025 | 0.048 |
| p-value (one-tail t test) | 0.0003 | | 0.0002 | |

### Example 7. Product Performance Study

Performance of a representative cream produced by the present technology (10% fat, using Enzyme 4) was compared to a control cream (40% fat) in an Alfredo pasta sauce product. The ingredients of the control sauce (Control) and the sauce containing a cream produced by the above method (Treated) are as follows.

| Ingredient | Control (wt %) | Treated (wt %) |
|---|---|---|
| Skim Milk | 44.56 | 44.56 |
| Cream (40% Fat) | 41.10 | — |
| Cream (10% fat), treated | — | 41.10 |
| Parmesan Cheese | 11.27 | 11.27 |
| Xanthan Gum | 0.09 | 0.09 |
| Garlic Powder | 0.27 | 0.27 |
| Black Pepper | 0.14 | 0.14 |
| Food Starch - Modified | 1.77 | 1.77 |
| Salt | 0.81 | 0.81 |
| Total | 100.00 | 100.00 |
| Total fat | 16.47 | 4.14 |

A sensory panel was implemented for an accurate, non-bias, and controlled analysis of the two products. The sensory panel used a 9-point hedonic scale (shown below) which is the most widely used scale for testing and measuring consumer acceptability of food.

9-Point Hedonic Scale

| | |
|---|---|
| 9 | Like Extremely |
| 8 | Like very Much |
| 7 | Like Moderately |
| 6 | Like Slightly |
| 5 | Neither Like nor Dislike |
| 4 | Dislike Slightly |
| 3 | Dislike Moderately |
| 2 | Dislike Very Much |
| 1 | Dislike Extremely |

Each sample was coded with a randomly generated 3-digit number, so the panelists were not biased and the tasting was considered blind. Samples were presented in all possible permutations to reduce any presentation order biases and panelists were instructed to taste the samples from left to right to keep consistencies. Panelists were screened and selected based on being a regular consumer, meaning they consumed alfredo at least once a month. With this selection criteria, ninety-nine (99) panelists were selected to participate. Panelists were asked to score the two Alfredo pasta sauces on four different sensory categories: overall liking, overall flavor liking, sauce overall liking, and creaminess liking. While “overall liking” and “overall flavor liking” are categories that are commonly used in a hedonic sensory test, “sauce overall liking” and “creaminess liking” were added as an emphasis on attributes related to Alfredo pasta sauces. With a score of six (6) as “Like Slightly” and a score of seven (7) as “Like Moderately”, the average results of the panelists' responses are showed in Table 4.

TABLE 4

| Category | Control | Treated |
|---|---|---|
| Overall Liking | 7.26 | 6.90 |
| Overall Flavor Liking | 7.07 | 6.80 |
| Sauce Overall Liking | 7.12 | 6.77 |
| Creaminess Liking | 6.97 | 6.56 |

These results show that the Alfredo pasta sauces containing the control cream (40% fat) and the cream produced by the present method (10% fat) demonstrated relatively equal sensory performance. Despite their difference in “Creaminess Liking” (a difference of 0.41 in their scores), both products were rated close to “Like Moderately.”

For reasons of completeness, various aspects of the disclosure are set out in the following numbered clauses:

Clause 1. A method for preparing a food product, comprising mixing a lipase with a base composition comprising a phospholipid and 0% to about 99% by weight of fat, wherein the lipase catalyzes a hydrolysis of the phospholipid, the fat, or a combination thereof.

Clause 2. The method of clause 1, wherein the base composition comprises a milk, a modified milk, a plant-based milk alternative, or a combination thereof.

Clause 3. The method of any one of clauses 1-2, wherein the base composition comprises a modified milk.

Clause 4. The method of any one of clauses 1-3, wherein the base composition comprises 0.1% to about 45% by weight of fat.

Clause 5. The method of any one of clauses 1-4, further comprising inactivating the lipase after the hydrolysis.

Clause 6. The method of any one of clauses 1-5, wherein the hydrolysis is carried out at a temperature of about 50° F. to about 150° F.

Clause 7. The method of any one of clauses 1-6, wherein the hydrolysis is carried out for a time period of about 10 minutes to about 150 minutes.

Clause 8. The method of any one of clauses 1-7, wherein the phospholipid is hydrolyzed to produce a lysophospholipid.

Clause 9. The method of any one of clauses 1-8, further comprising adding a flavorant.

Clause 10. The method of any one of clauses 1-9, further comprising adding an antioxidant.

Clause 11. A food product produced by the method of any one of clauses 1-10.

Clause 12. The food product of clause 11, which is essentially free of added emulsifiers or texturizing agents.

Clause 13. The food product of any one of clauses 11-12, comprising about 5% to about 25% by weight of fat.

Clause 14. The food product of any one of clauses 11-13, having a viscosity of about 1000 cP to about 1200000 cP at 40° F.

Clause 15. The food product of any one of clauses 11-14, having a viscosity of about 20000 cP to about 600000 cP at 40° F.

Clause 16. The food product of any one of clauses 11-15, which is stable for at least 30 days at 40° F.

Clause 17. The food product of any one of clauses 11-15, which is in the form of a cream.

Clause 18. The food product of clause 17, comprising about 10% by weight of fat.

Clause 19. A food composition comprising the food product of clause 11.

Clause 20. The food composition of clause 19, which is a sauce, a salad dressing, a drink, or a soup.

It is understood that the foregoing detailed description and accompanying examples are merely illustrative and are not to be taken as limitations upon the scope of the invention, which is defined solely by the following claims.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

What is claimed is:

1. A method for preparing a food product, comprising mixing a lipase with a base composition comprising a phospholipid and 0% to about 99% by weight of fat, wherein the lipase catalyzes a hydrolysis of the phospholipid, the fat, or a combination thereof.

2. The method of claim 1, wherein the base composition comprises a milk, a modified milk, a plant-based milk alternative, or a combination thereof.

3. The method of claim 1, wherein the base composition comprises a modified milk.

4. The method of claim 1, wherein the base composition comprises 0.1% to about 45% by weight of fat.

5. The method of claim 1, further comprising inactivating the lipase after the hydrolysis.

6. The method of claim 1, wherein the hydrolysis is carried out at a temperature of about 50° F. to about 150° F.

7. The method of claim 1, wherein the hydrolysis is carried out for a time period of about 10 minutes to about 150 minutes.

8. The method of claim 1, wherein the phospholipid is hydrolyzed to produce a lysophospholipid.

9. The method of claim 1, further comprising adding a flavorant.

10. The method of claim 1, further comprising adding an antioxidant.

11. A food product produced by the method of claim 1.

12. The food product of claim 11, which is essentially free of added emulsifiers or texturizing agents.

13. The food product of claim 11, comprising about 5% to about 25% by weight of fat.

14. The food product of claim 11, having a viscosity of about 1000 cP to about 1200000 cP at 40° F.

15. The food product of claim 11, having a viscosity of about 20000 cP to about 600000 cP at 40° F.

16. The food product of claim 11, which is stable for at least 30 days at 40° F.

17. The food product of claim 11, which is in the form of a cream.

18. The food product of claim 17, comprising about 10% by weight of fat.

19. A food composition comprising the food product of claim 11.

20. The food composition of claim 19, which is a sauce, a salad dressing, a drink, or a soup.
